(19) United States
(12) Patent Application Publication
(10) Pub. No.: US 2020/0096319 A1
(43) Pub. Date: Mar. 26, 2020

(54) DEVICE FOR ASSESSING AND PROVIDING QUALITY FEEDBACK IN THORACIC COMPRESSIONS DURING CARDIOPULMONARY RESUSCITATION

(71) Applicant: UNIVERSIDAD DE LA SABANA, Chia (CO)

(72) Inventors: Daniel Alfonso BOTERO ROSAS, Chia (CO); Alirio Rodrigo BASTIDAS GOYES, Chia (CO); Jaime FERNANDEZ, Chia (CO); Juan Pablo CONTRERAS, Chia (CO)

(21) Appl. No.: 16/606,756

(22) PCT Filed: May 9, 2018
(86) PCT No.: PCT/CO2018/000010

§ 371 Date: Oct. 20, 2019

(30) Foreign Application Priority Data
Aug. 10, 2017 (CO) NC2017/0008062

(51) Int. Cl. G01B 11/14; A61H 31/00

(52) U.S. Cl. CPC G01B 11/14; A61H 2201/1253; A61H 31/007

(57) ABSTRACT

The present invention describes a device for assessing and providing quality feedback on thoracic compressions during cardiopulmonary resuscitation, which allows for an optimal assessment of the quality of the thoracic compressions made during cardiopulmonary resuscitation, which provides feedback on the position of said compressions. The device for assessing and providing quality feedback on thoracic compressions during cardiopulmonary resuscitation, by means of the elements thereof together with essential technical features thereof, such as an infrared sensor, a microprocessor, logic means, a graphic interface and remote connectivity means, makes it possible to estimate the depth and frequency parameters of the thoracic compressions, in order to determine whether they are adequate during a cardiopulmonary resuscitation procedure.

### GENERAL AND DETAILED DESCRIPTION OF THE INVENTION

The objective technical problem of the present application is to avoid an inadequate application of the CPR in patients, which can cause deterioration in the survival of the patient with cardiorespiratory arrest.

The present invention patent aims to provide the solution to the problem by means of a device for assessing and providing quality feedback on thoracic compressions during cardiopulmonary resuscitation comprising its respective constructive dispositions or configurations together with their essential technical characteristics, which allow to optimally evaluate the quality of the thoracic compressions performed at the time of a cardiopulmonary resuscitation, which provides a feedback in the disposition of said compressions. Likewise, this device allows estimating the parameters of depth and frequency of thoracic compressions, in order to determine if these are adequate during a cardiopulmonary resuscitation procedure.

The referenced documents of the state-of-the-art show part of the state of the art of the same technological field of the application, as it is observed in the US invention patents US 2017143584 and US 2015351647, also with the article published “Real time auto feedback system for chest compressions using an infrared camera” by the author Kouichiro Minami et al.

Based on the foregoing, those documents that are part of the state of the technique, in order to expose the background of the application and take as a starting point the improvements that make the application different by its essential technical characteristics that solve the technical problem of the objective raised in the application.

It is observed that monitoring is an important part of emergency medicine and critical care. This has entered the routine of the management of any patient that requires cardiopulmonary resuscitation, which may be performed in hospitalization and even in the prehospital setting. The main purpose of monitoring is to obtain frequent, repeated and continuous measurements of the physiological functions, which may be obtained at the patient's bedside, to allow for early recognition of the physiological and/or technical problems, as well as the initiation or early correction of the therapy.

In cardiopulmonary resuscitation, science has evolved dramatically in recent decades, and the advent of new and sophisticated monitoring devices have shown that performing CPR is often inadequate in most cases. Therefore, the guidelines on cardiopulmonary resuscitation and emergency cardiovascular care from the American Heart Association (AHA) make clear the fact that, in most emergencies, the quality of CPR applied by a resuscitator can represent the difference between life and death. However, even trained professionals often do not apply CPR optimally and may take advantage of the benefits of monitoring and support. Thus, the AHA has increasingly highlighted the value of the audiovisual feedback of the CPR, to improve the quality of thoracic compressions applied by health care providers.

Based on the foregoing, the present application for an Invention Patent is created as a project in response to the approach of a solution to a problem that is currently in the field of biomedical engineering, especially in the field of cardiology, which was developed at the La Sabana University, located at the university campus of the Municipality of Chia, Cundinamarca.

The device for assessing and providing quality feedback on thoracic compressions during cardiopulmonary resuscitation (1), consists of the following essential components: at least one infrared sensor (2), a microprocessor (3), a logical means (4), a graphic interface (5), remote connection means (6). (See FIG. 1, FIG. 2, FIG. 3, FIG. 4 and FIG. 5).

In the preferred aspect of the invention, the infrared sensor (2) is a proximity sensor that includes a non-linear photosensitive film (2.1) where the infrared light that bounces on the surface of the resuscitator's hand is reflected. Similarly, this infrared sensor (2) has an infrared LED (2.2) and lenses (2.3). Also, the appearance for the microprocessor (3) can have any configuration for this type of element, and the preferred aspect for the graphic interface (5) has a color touch screen (5.1). Additionally, the preferred setup for remote connectivity means (6) is via wireless network of personal area. (See FIG. 1 and FIG. 4).

Particularly, the infrared sensor (2) is located on a support directly above the patient's chest; this infrared sensor (2) by means of an infrared LED (2.2) throws a beam of infrared light that passes through a lens (2.3) projecting on the hand of the person who performs the thoracic compressions allowing to estimate the depth and frequency of thoracic compressions. Once the infrared beam is reflected in a non-specular manner over the hand of the resuscitator, it is reflected and projects again the beam of infrared light which passes through the lens (2.3) toward the infrared sensor (2), where said sensor (2) emits an analogous voltage corresponding to the distance of the hand. The infrared sensor (2) is coupled to the microprocessor (3). The infrared sensor (2) also includes one or more LEDs (2.2), which allow to verify the position of the sensor (2) by illuminating the measuring point.

Particularly, the microprocessor (3) houses the logical means (4) and an A/D converter (3.1). The latter performs a minimum sampling of (one) 1 distance measurement at a frequency of at least 5 Hz. This ND converter (3.1) receives the analog voltage signal and transforms it into a digital signal.

Accordingly, the logical means (4) that are housed in the microprocessor (3), analyze the information captured by the infrared sensor (2) and determine the quality of the thoracic compressions. Additionally, in order to calculate the compression frequency, they count the time it takes for a compression to return to the initial distance and obtains the results through a series of mathematical operations.

The device (1) also consists of a graphic interface (5) located on the support, which presents the information synthesized by the logical means (4) and provides feedback on the quality of compressions. Particularly, the graphic representation allows the possibility of choosing the type of patient (newborn, child or adult) to know if the data obtained during resuscitation is in accordance with the requirements of the American Heart Association (AHA). If the procedure is performed well, the depth and frequency information will appear in green color; and if the procedure is wrong, it will appear in red color. In relation to the frequency, it is also shown by an up or down arrow, if the compression frequency should be increased or decreased.

Accordingly, the device (1) includes remote connectivity means (6) that send the information to an associated mobile application. This application includes a version of the graphic interface (5) and presents synthesized information about the quality and feedback of thoracic compressions.

The device for assessing and providing quality feedback on thoracic compressions during cardiopulmonary resuscitation (1) has an infrared sensor (2) that is located on a fixed support. This infrared sensor (2) is located directly above the patient's chest to a set distance, allowing to estimate the depth and frequency parameters of the thoracic compressions, in order to determine if these are suitable during a cardiopulmonary resuscitation procedure. The infrared sensor (2) by means of an infrared LED (2.2) projects an infrared beam of light on the back of the hand of the person who performs thoracic compressions. Likewise, this device (1) has a graphic interface (5). This graphical interface (5) is intended to present the information processed by the logical means (4), and in turn, provides feedback about the quality of compressions. The device (1) also has means of remote connectivity (6) that allow to send the information to an associated mobile application and provides the option to connect to it. This mobile application includes a version of the graphic interface (5), which presents the synthesized information related to the quality and feedback of thoracic compressions. The infrared sensor (2) of the device (1) has lenses (2.3).

Calibration, measurement and validation tests of the device for assessing and providing quality feedback on thoracic compressions during cardiopulmonary resuscitation (1) are illustrated below in order to present this invention with greater precision without limiting its inventive concept, applications and scope.

### CALIBRATION AND MEASUREMENT TEST WITH THE DEVICE (1)

In order to calculate the calibration distance by the triangulation method, a test was carried out with the device (1) using its infrared sensor (2), to linearize its voltaic response at distances between 10 cm and 60 cm (see FIG. 1). This allows maximizing the spatial resolution of the analysis distances used during cardiopulmonary resuscitation.

The infrared sensor (2) was pointed towards the back of the resuscitator's hand when it is placed over the cardiac massage site. The infrared LED light (2.2) implemented in the sensor was used (2) to show the place in the hand of the resuscitator where the calibration will be performed, and subsequently, the depth measurements.

During calibration, the beam or infrared light beam emitted by the sensor (2) reaches the hand of the resuscitator and is reflected in a non-specular way toward a non-linear photosensitive film (2.1) of the infrared sensor (2) coupled to the microprocessor (3). The sensor (2) emits an analogous voltage corresponding to the distance of the object and establishes the calibration distance (CD), which is defined as the zero or minimum travel point.

After the calibration distance (CD) was obtained, cardiac compressions were started. The infrared sensor (2) emitted then rays or beams of infrared light in a continuous way on the hand of the resuscitator, calculating the distances. The analog voltage information was digitized by the A/D converter (3.1), and later analyzed by the logical means (4), thus allowing to provide feedback. Finally, the data and the feedback were exported to the graphic interface (5), allowing to conduct a successful simulated resuscitation.

### VALIDATION OF THE DEVICE (1)

Once the device has been calibrated (1) and for its clinical validation, a test will be performed on FDA-approved mannequins (adults, children and newborns) that report the depth; and additionally, there will be a laser distance meter that will report distances and compression frequency. The total number of tests will be at least 120 per mannequin and distance meter.

Based on the above, this will allow us to evaluate and compare our device (1) with the reports provided by the mannequin and the distance meter. Subsequently, the Pearson correlation analysis will be performed between the measurements reported by the device (1) and those provided by the mannequin and the distance meter.

Conformance evaluations will also be conducted using the Bland-Altman test. In addition, a concordance test will be implemented by calculating the Kappa statistic to evaluate the concordances with adequate or unsuitable compressions marked by the mannequin.

A value greater than 0.9 with p≤0.05 will be taken as the appropriate kappa. This validation can demonstrate the efficacy of the device (1) in relation to AHA recommendations.

### BRIEF DESCRIPTION OF THE FIGURES

FIG. 1 shows a front view of the infrared sensor (2) of the device for assessing and providing quality feedback on thoracic compressions during cardiopulmonary resuscitation (1), showing all its constructive technical characteristics and its respective assembly. Also, FIG. 1 shows the triangulation method for the calculation of the distances implemented in the calibration and measurement of the depth during each compressive cycle, which has an infrared LED (2.2), lenses (2.3), a scattered reflection (3), a distant object (4), a near object (5), a non-linear, position photosensitive film (2.1).

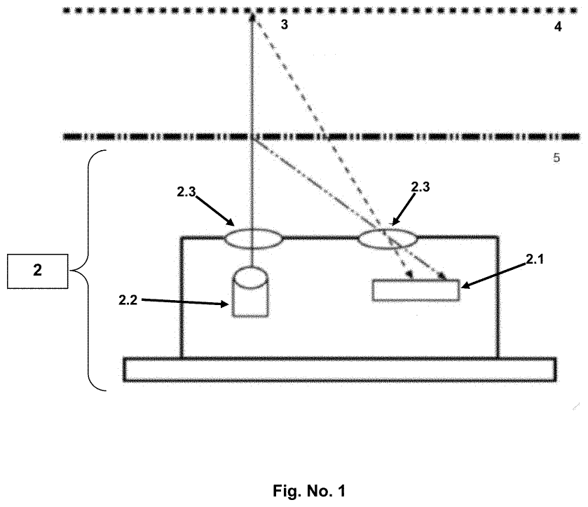

FIG. 2 shows a frontal orthogonal view of the device for assessing and providing quality feedback on thoracic compressions during cardiopulmonary resuscitation (1) where the infrared sensor (2) placed on a fixed support is observed, and it shows the patient lying on his back, and it is shown that said infrared sensor (2) is located above the patient's chest.

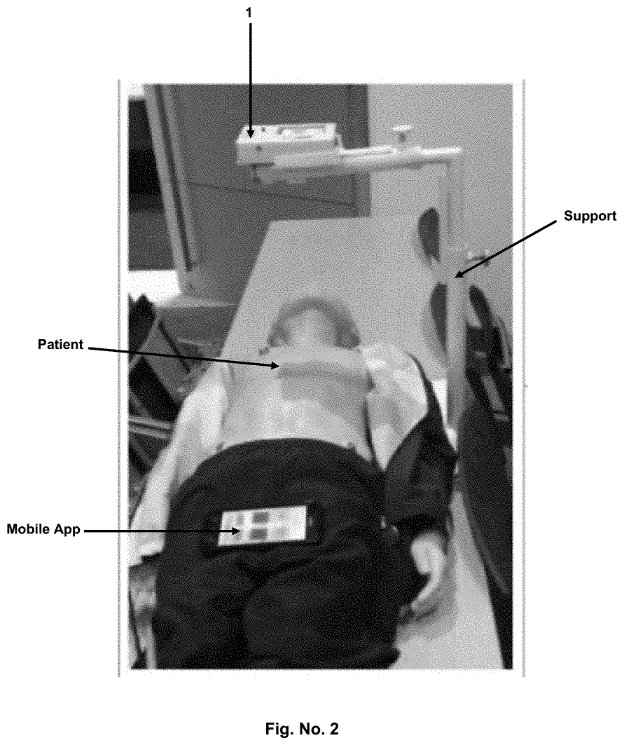

FIG. 3 shows a schematic drawing of the device for assessing and providing quality feedback on thoracic compressions during cardiopulmonary resuscitation (1) showing its elements such as the infrared sensor (2), the microprocessor (3), the logical means (4), the graphic interface (5) with its touch screen (5.1) and the remote connection means (6).

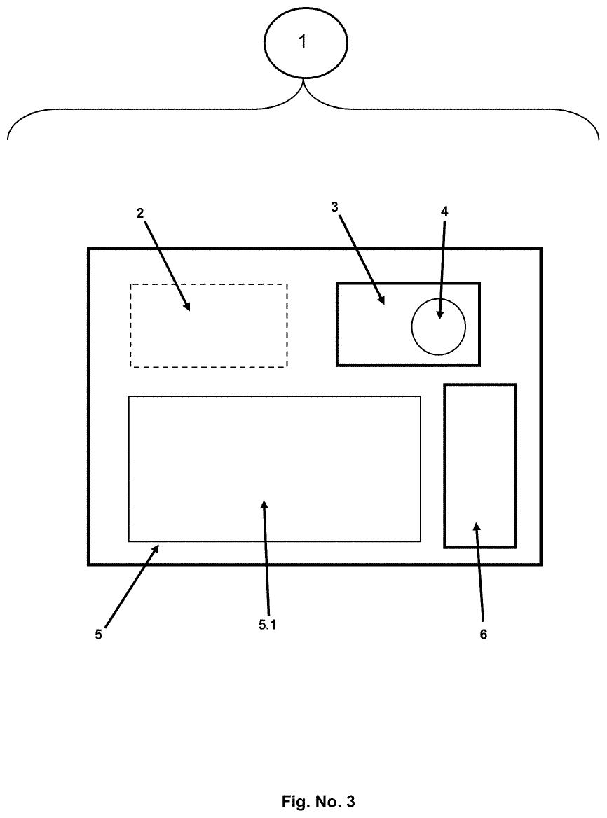

FIG. 4 shows a top orthogonal view of the device for assessing and providing quality feedback on thoracic compressions during cardiopulmonary resuscitation (1), which shows that this device (1) together with its graphic interface (5) and its touch screen (5.1) that report the depth and frequency of compression. Additionally, it shows an icon to choose the type of resuscitation to be performed (adult, child, newborn), and finally shows the elapsed time during resuscitation.

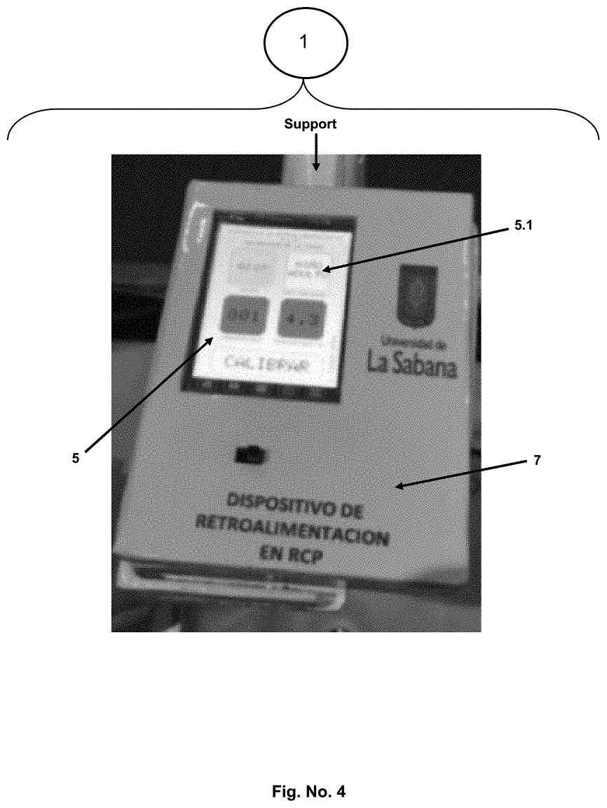

FIG. 5 shows a top orthogonal view of a mobile device. It is also observed that the device (1) operates on said mobile device with the same information in real time provided on the graphic interface (5) of the device (1).

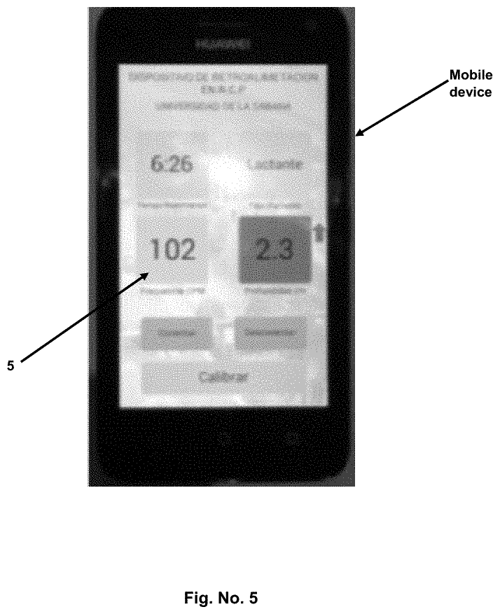

1. The device for assessing and providing quality feedback on thoracic compressions during cardiopulmonary resuscitation (1) characterizes because it has at least one infrared sensor (2), a microprocessor (3), logical means (4), a graphic interface (5), and remote connection means (6).

2. The device for assessing and providing quality feedback on thoracic compressions during cardiopulmonary resuscitation (1), according to claim 1 above, characterizes because the infrared sensor (2) is a proximity sensor that includes a non-linear photosensitive film (2.1), it also includes one or more LEDs (2.2) and lenses (2.3).

3. The device for assessing and providing quality feedback on thoracic compressions during cardiopulmonary resuscitation (1), according to claim 1 above, characterizes because the microprocessor (3) can have any configuration for this type of element, and also houses the logical means (4) and an A/D converter (3.1).

4. The device for assessing and providing quality feedback on thoracic compressions during cardiopulmonary resuscitation (1), according to claim 1 above, characterizes because the graphic interface (5) has a color touch screen (5.1).

5. The device for assessing and providing quality feedback on thoracic compressions during cardiopulmonary resuscitation (1), according to claim 1 above, characterizes because the remote connectivity means (6) are personal wireless network-based.

6. The device for assessing and providing quality feedback on thoracic compressions during cardiopulmonary resuscitation (1), according to claims 1 and 2 above, characterizes because the infrared sensor (2) is located directly above the patient's chest. This infrared sensor (2) by means of an infrared LED (2.2) throws a beam of infrared light that passes through a lens (2.3) projecting on the hand of who is performing the thoracic compressions. Once the beam of infrared light is reflected in a non-specular way on the hand of the resuscitator, the beam of infrared light is reflected and projected again, which passes through the lens (2.3) toward the infrared sensor (2), where this sensor (2) emits an analogous voltage corresponding to the distance of the hand. The voltage information generated by the sensor (2) is transmitted to a microprocessor (3).

7. The device for assessing and providing quality feedback on thoracic compressions during cardiopulmonary resuscitation (1), according to claims 1, 3 and 6 above, characterizes because the microprocessor (3) that houses an A/D performs a minimum sampling of one (1) distance measurement at a frequency of at least 5 Hz. This A/D converter (3.1) receives the analog voltage signal and transforms it into a digital signal.

8. The device for assessing and providing quality feedback on thoracic compressions during cardiopulmonary resuscitation (1), according to claims 1 and 4 above, characterizes because the graphic interface (5) presents the information synthesized by the logical means (4) and provides feedback about the quality of compressions.

9. The device for assessing and providing quality feedback on thoracic compressions during cardiopulmonary resuscitation (1), according to claims 1, and 4 above, characterizes because the remote connectivity means (6) send the information to an associated mobile application.
